(19) United States
(12) Patent Application Publication
(10) Pub. No.: US 2026/0211249 A1
(43) Pub. Date: Jul. 23, 2026

(54) DETACHABLE VIRTUAL REALITY DEVICE

(71) Applicant: ASUSTeK COMPUTER INC., Taipei (TW)

(72) Inventor: Ming-Feng Hsu, Taipei (TW)

(21) Appl. No.: 19/455,991

(22) Filed: Jan. 22, 2026

(30) Foreign Application Priority Data
Jan. 23, 2025 (TW) 114103240

(51) Int. Cl. G02B 27/01

(52) U.S. Cl. CPC G02B 27/0176

(57) ABSTRACT

A detachable virtual reality device is disclosed, which is placed on a user and is at a first position on the user. The detachable virtual reality device includes a detachable headset and a detachable host. The detachable headset is placed on the head of the user and has a second position. The detachable host is electrically connected to the detachable headset. The detachable host selects a corresponding first power table or a corresponding second power table depending on whether the detachable host is placed at the first position or the second position, to transmit and receive radio frequency signals according to the first power table or the second power table. Therefore, different power tables are selected according to the location of the detachable host.

### CROSS-REFERENCE TO RELATED APPLICATIONS

This application claims the priority benefit of Taiwan Application Serial No. 114103240, filed on January 23, 2025. The entirety of the above-mentioned patent application is hereby incorporated by reference herein and made a part of specification. BACKGROUND OF THE INVENTION

### BACKGROUND OF THE INVENETION

### FIELD OF THE INVENTION

The disclosure relates to a detachable virtual reality (VR) device with selectable wireless communication power.

### DESCRIPTION OF THE RELATED ART

A specific absorption rate (Specific Absorption Rating, SAR) of electromagnetic waves is an indicator of measuring an absorption rate of a human body when the human body is exposed to electromagenetic wave radiation. To avoid adverse effects of the electromagenetic wave radiation on the human body, relevant government agencies establish regulatory specified values for SAR safety standards to clearly define maximum safe values allowed for different parts of the human body. In an embodiment of a virtual reality device, the virtual reality device primarily creates virtual 3D space by using a computer, usually includes a VR helmet with a display to play various 3D simulated scenes, and transmits and receives radio frequency signals by using a VR host. Because the head-mounted VR helmet and the VR host in the virtual reality device are designed in an integrated manner, there is only one power table for use, without the need for additional power tables.

### BRIEF SUMMARY OF THE INVENTION

The disclosure provides a detachable virtual reality device, which is placed on a user and is at a first position on the body of the user. The detachable virtual reality device includes a detachable helmet and a detachable host. The detachable helmet is placed on the head of the user and has a second position. The detachable host is electrically connected to the detachable helmet. The detachable host selects a corresponding first power table or a corresponding second power table depending on whether the detachable host is placed at the first position or the second position, to transmit and receive radio frequency signals according to the first power table or the second power table.

In summary, based on a detachable virtual reality architecture, a specific absorption rate needs to satisfy different regulatory specified values. Accordingly, the disclosure provides a detachable virtual reality device that detects a position of a detachable host on a user based on different conditions, to select different power tables based on the position of the detachable host. Therefore, the detachable virtual reality device in the disclosure adaptively selects a suitable power table to automatically adjust communication power to comply with SAR regulations, thereby improving product safety.

### BRIEF DESCRIPTION OF THE DRAWINGS

FIG. 1 is a block diagram of a detachable virtual reality device according to an embodiment of the disclosure;

FIG. 2 is a schematic diagram of a detachable virtual reality device, in which the detachable host is placed at a first position, according to an embodiment of the disclosure;

FIG. 3 is a schematic diagram of a detachable virtual reality device, in which the detachable host is placed at a second position, according to an embodiment of the disclosure; and

FIG. 4 is a schematic diagram of a detachable virtual reality device, in which the detachable host is placed at a second position, according to another embodiment of the disclosure.

### DETAILED DESCRIPTION OF THE EMBODIMENTS

The following describes embodiments of the disclosure with reference to related drawings. In addition, some elements or structures are omitted in the drawings in embodiments to clearly illustrate technical features of the disclosure. In these drawings, the same reference numerals represent the same or similar elements or circuits. It should be understood that although terms "first", "second", and the like are used in this specification to describe various elements, components, regions or functions, these elements, components, regions and/or functions should not be limited by these terms. These terms are only used to distinguish one element, component, region or function from another element, component, region or function.

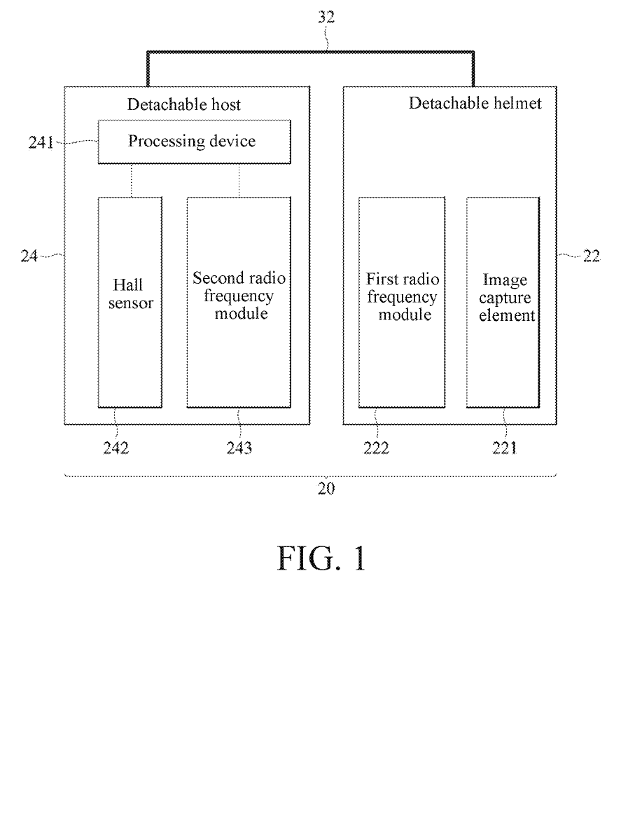

Refer to FIG. 1. A detachable virtual reality device 20 is provided to place on a user 10 at a first position 12. In embodiments, the first position 12 is usually on a limb or the body of the user 10. The detachable virtual reality device 20 includes a detachable helmet 22 and a detachable host 24. The detachable helmet 22 is placed on the head of the user 10. The detachable helmet 22 is a helmet with a display and is placed at a second position 26. The second position 26 is close to the head of the user 10. The detachable host 24 is electrically connected to the detachable helmet 22. The detachable host 24 executes a detection mechanism, to select a corresponding first power table or a corresponding second power table depending on whether the detachable host 24 is placed at the first position 12 or the second position 26, and transmits and receives radio frequency signals according to the first power table or the second power table.

In an embodiment, the first power table includes a preset communication power value at the first position 12. The communication power prediction value is usually a regulatory specified value (maximum power value) corresponding to the first position 12 as specified by SAR regulations. The second power table includes a preset communication power value at the second position 26. The communication power prediction value is usually a regulatory specified value (maximum power value) corresponding to the second position 26 as specified by the SAR regulations. The first power table and the second power table are stored in a storage device (not shown) in the detachable host 24, so that the detachable host 24 selects the corresponding first power table or the corresponding second power table from the storage device based on a position of the detachable host 24. In an embodiment, the storage device is a non- volatile memory.

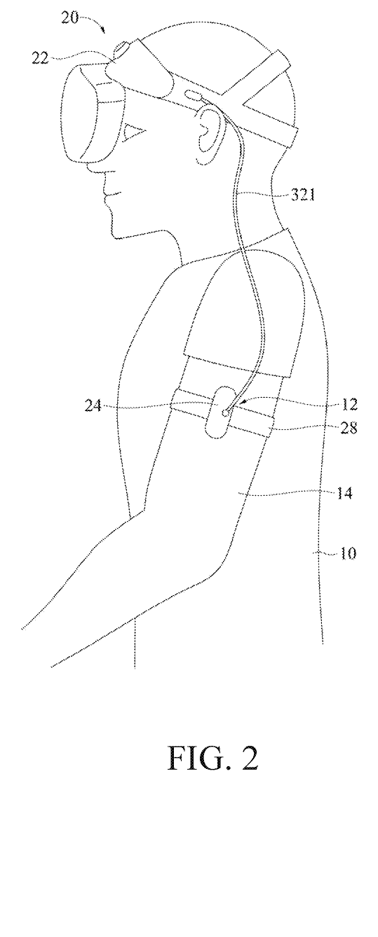

Refer to FIG. 1 and FIG. 2. The detachable host 24 is placed at the first position 12 on the user 10 by using a strap 28. In an embodiment, the detachable host 24 is placed on the arm 14 or the waist of the user 10 by using the strap 28. In this embodiment, the detachable host 24 is mounted on the arm 14 of the user 10, but the disclosure is not limited thereto. When the detachable host 24 is placed at the first position 12 on the arm 14 of the user 10 by using the strap 28, the first position 12 is relatively far from the detachable helmet 22. Therefore, the position of the detachable host 24 is determined by using the detection mechanism. In this case, it is determined that the detachable host 24 is at the first position 12, and therefore the first power table suitable for the first position 12 is selected.

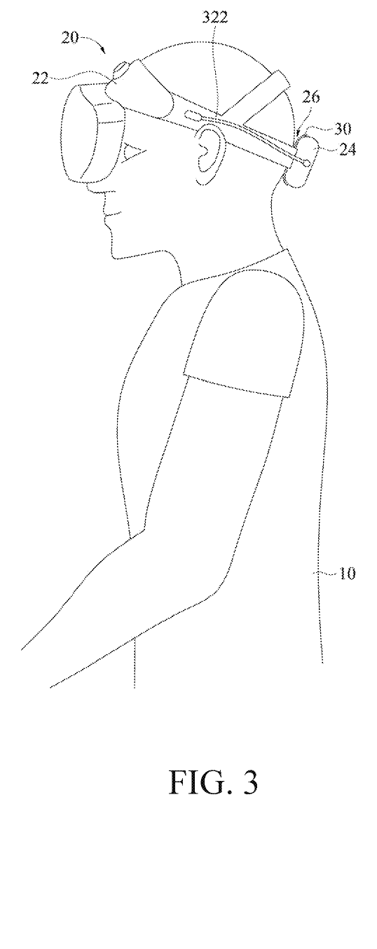

Refer to FIG. 1 and FIG. 3. A supporting seat 30, like a buckle seat, is further provided at the second position 26 of the detachable helmet 22, to allow the detachable host 24 to be mounted on the supporting seat 30. When the detachable host 24 is mounted at the second position 26 on the detachable helmet 22 by using the supporting seat 30, the second position 26 is close to the detachable helmet 22. Therefore, the position of the detachable host 24 is determined by using the detection mechanism. In this case, it is determined that the detachable host 24 is at the second position 26, and therefore the second power table suitable for the second position 26 is selected.

Refer to FIG. 1, FIG. 2, and FIG. 3 together. In the detachable virtual reality device 20, the detachable host 24 further includes a built-in processing device 241, to use the processing device 241 to execute the detection mechanism to determine whether the detachable host 24 is placed at the first position 12 or the second position 26. Various different detection mechanisms are described below.

In an embodiment, the detachable host 24 further includes a Hall sensor (Hall sensor) 242. There are one or more Hall sensors 242. In this embodiment, one Hall sensor 242 is used in an embodiment, but a quantity of Hall sensors 242 is determined based on actual needs and the disclosure is not limited thereto. The Hall sensor 242 is electrically connected to the processing device 241, to detect, by using the Hall sensor 242, whether the detachable host 24 is placed at the first position 12 or the second position 26, so as to select the suitable first power table or second power table.

In an embodiment, refer to FIG. 1, FIG. 2, and FIG. 3 together. The detachable virtual reality device 20 further includes a transmission cable 32. The detachable helmet 22 is connected to the detachable host 24 via the transmission cable 32. The transmission cable 32 is selected from a first transmission cable 321 or a second transmission cable 322. The first transmission cable 321 includes a first identifier, and the second transmission cable 322 includes a second identifier. When the detachable host 24 is placed at the first position 12, the detachable host 24 is connected to the detachable helmet 22 via the first transmission cable 321. When the detachable host 24 is placed at the second position 26, the detachable host 24 is connected to the detachable helmet 22 via the second transmission cable 322. Therefore, the processing device 241 identifies, based on the first identifier and the second identifier, whether the detachable host 24 is connected to the detachable helmet 22 via the first transmission cable 321 or the second transmission cable 322, to determine, via different transmission cables 32, whether the detachable host 24 is placed at the first position 12 or the second position 26. When the processing device 241 detects the first identifier, it indicates that the detachable helmet 22 is connected to the detachable host 24 via the longer first transmission cable 321. Therefore, the detachable host 24 is placed at the first position 12, as shown in FIG. 2, and the suitable first power table is selected. When the processing device 241 detects the second identifier, it indicates that the detachable helmet 22 is connected to the detachable host 24 via the shorter second transmission cable 322. Therefore, the detachable host 24 is placed at the second position 26, as shown in FIG. 3, and the suitable second power table is selected.

In an embodiment, the detachable helmet 22 further includes a plurality of image capture elements 221. The detachable helmet 22 captures surrounding images by using the image capture element 221 and transmits the images to the processing device 241 in the detachable host 24 via the transmission cable 32, so that the processing device 241 determines, based on the images, whether the detachable host 24 is placed at the first position 12 or the second position 26 to select the suitable first power table or the second power table.

In an embodiment, the detachable helmet 22 further includes a first radio frequency module 222, the detachable host 24 further includes a second radio frequency module 243, and the second radio frequency module 243 is electrically connected to the processing device 241. The detachable host 24 alternatively determines, based on radio frequency intensity between the second radio frequency module 243 and the first radio frequency module 222, whether the detachable host 24 is placed at the first position or the second position. When the detachable host 24 reads the first radio frequency module 222 of the detachable helmet 22 by using the second radio frequency module 243, if radio frequency intensity of a radio frequency signal is weak, it indicates that a distance between the detachable host 24 and the detachable helmet 22 is long. Therefore, the detachable host 24 is placed at the first position 12, as shown in FIG. 2, and the suitable first power table is selected; or if radio frequency intensity of a radio frequency signal is strong, it indicates that a distance between the detachable host 24 and the detachable helmet 22 is short. Therefore, the detachable host 24 is placed at the second position 26, as shown in FIG. 3 and the suitable second power table is selected.

In an embodiment, the processing device 241 is a central processing unit (central processing unit, CPU), or another general-purpose or special-purpose microprocessor (microprocessor), microcontroller (microcontroller), micro control unit (micro control unit, MCU), digital signal processor (digital signal processor, DSP), programmable controller, application specific integrated circuit (application specific integrated circuit, ASIC), or another similar element or a combination of the foregoing elements, but the disclosure is not limited thereto.

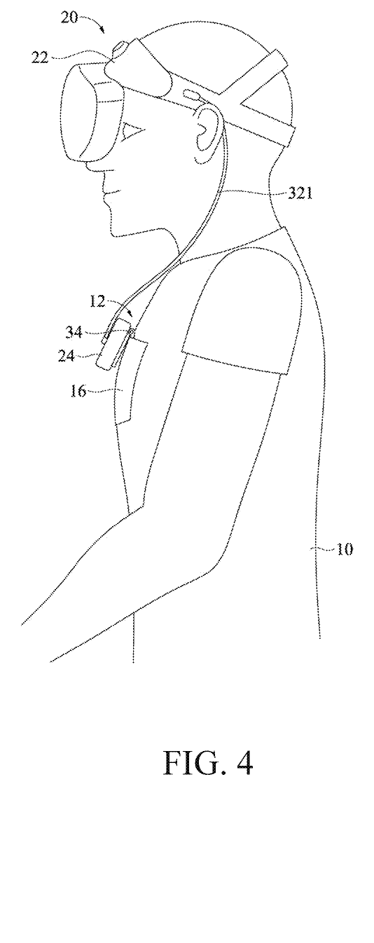

In an embodiment, refer to FIG. 4. The detachable host 24 is alternatively placed at the first position 12 on the user 10 by using a clamping member 34. The clamping member 34 is a clip or a buckle. In an embodiment, the detachable host 24 is placed on a pocket 16 of the user 10 by using the clamping member 34. In this embodiment, the detachable host 24 is mounted on the pocket 16 of a shirt of the user 10, but the disclosure is not limited thereto. The detachable host 24 is placed at any position of the user 10 by using the clamping member 34. When the detachable host 24 is placed at the first position 12 on the pocket 16 of the user 10 by using the clamping member 34, the first position 12 is relatively far from the detachable helmet 22. Therefore, the position of the detachable host 24 is determined by using the detection mechanism. In this case, it is determined that the detachable host 24 is at the first position 12, and therefore the first power table suitable for the first position 12 is selected.

In summary, based on a detachable virtual reality architecture, a specific absorption rate (SAR) needs to satisfy different regulatory specified values. Accordingly, the disclosure provides a detachable virtual reality device that detects a position of a detachable host on a user based on different conditions, to select different power tables based on the position of the detachable host. Therefore, the detachable virtual reality device in the disclosure adaptively selects a suitable power table to automatically adjust communication power to comply with SAR regulations, thereby improving product safety.

The foregoing embodiments are merely illustrative of the technical concepts and features of the disclosure. The objective is to cause a person skilled in the art to understand content of the disclosure and implement the content accordingly. But the scope of the patent application of the disclosure is not limited thereto. In other words, any equivalent variations or modifications made in accordance with the spirit disclosed in the disclosure shall still be included in the scope of the patent application of the disclosure.

What is claimed is:

1. A detachable virtual reality device, adapted to be placed on a user at a first position, the detachable virtual reality device comprising:
a detachable helmet, placed on the user at a second position; and
a detachable host, electrically connected to the detachable helmet, wherein the detachable host selects a corresponding first power table or a corresponding second power table depending on whether the detachable host is placed at the first position or the second position, to transmit and receive radio frequency signals according to the first power table or the second power table.

2. The detachable virtual reality device according to claim 1, wherein the detachable host further comprises a built-in processing device, and the processing device determines whether the detachable host is placed at the first position or the second position.

3. The detachable virtual reality device according to claim 2, wherein the detachable host further comprises a Hall sensor, and the Hall sensor is electrically connected to the processing device to detect, by using the Hall sensor, whether the detachable host is placed at the first position or the second position.

4. The detachable virtual reality device according to claim 2, further comprising a transmission cable, wherein the detachable helmet is connected to the detachable host via the transmission cable.

5. The detachable virtual reality device according to claim 4, wherein the transmission cable is selected from a first transmission cable or a second transmission
cable, the first transmission cable comprises a first identifier and the second transmission cable comprises a second identifier, the detachable host is connected to the detachable helmet via the first transmission cable when the detachable host is placed at the first position, the detachable host is connected to the detachable helmet via the second transmission cable when the detachable host is placed at the second position, and the processing device identifies, based on the first identifier and the second identifier, whether the detachable host is connected to the detachable helmet via the first transmission cable or the second transmission cable, to determine whether the detachable host is placed at the first position or the second position.

6. The detachable virtual reality device according to claim 2, wherein the detachable helmet further comprises a plurality of image capture elements, and the image capture elements are used to capture images to provide the images for the processing device to determine whether the detachable host is placed at the first position or the second position.

7. The detachable virtual reality device according to claim 2, wherein the detachable helmet further comprises a first radio frequency module, and the detachable host further comprises a second radio frequency module, to determine, based on radio frequency intensity between the first radio frequency module and the second radio frequency module, whether the detachable host is placed at the first position or the second position.

8. The detachable virtual reality device according to claim 1, wherein a supporting seat is further provided at the second position of the detachable helmet, to allow the detachable host to be mounted on the supporting seat.

9. The detachable virtual reality device according to claim 1, wherein the
detachable host is placed at the first position on the user by using a strap.

10. The detachable virtual reality device according to claim 9, wherein the detachable host is placed at the first position on the arm or the waist of the user by using the strap.

11. The detachable virtual reality device according to claim 1, wherein the detachable host is placed at the first position on the user by using a clamping member.
